(19) United States
(12) Patent Application Publication
(10) Pub. No.: US 2011/0128223 A1
(43) Pub. Date: Jun. 2, 2011

(54) METHOD OF AND SYSTEM FOR DETERMINING A HEAD-MOTION/GAZE RELATIONSHIP FOR A USER, AND AN INTERACTIVE DISPLAY SYSTEM

(75) Inventors: Tatiana Aleksandrovna Lashina, Eindhoven (NL); Evert Jan Van Loenen, Waalre (NL); Omar Mubin, Eindhoven (NL)

(73) Assignee: Koninklijke Phillips Electronics N.V., Eindhoven (NL)

(21) Appl. No.: 13/056,726

(22) PCT Filed: Jul. 24, 2009
(86) PCT No.: PCT/IB2009/053214

§ 371 Date: Jan. 31, 2011

(30) Foreign Application Priority Data
Aug. 7, 2008 (EP) 08104982.7

(51) Int. Cl. G06F 3/033

(52) U.S. Cl. 345/158

(57) ABSTRACT

The invention describes a method of determining a head-motion/gaze relationship for a user (1), which method comprises the steps of allocating at least one first target (T₁) and at least one second target (T₂) in a display area (D); attracting the user's gaze towards a first target (T₁) and observing the user's head (H) to obtain a first head orientation measurement value (M₁). The method further comprises the steps of subsequently attracting the user's gaze towards a second target (T₂) and observing the user's head (H) to obtain a second head orientation measurement value (M₂); and analysing the head orientation measurement values (M₁, M₂) to obtain a head-motion/gaze relationship (R) for that user (1). The invention further describes an interactive display system (2), and a method of performing a gaze-based interaction between a user (1) and an interactive display system (2).

### FIELD OF THE INVENTION

The invention describes a method of and a system for determining a head-motion/gaze relationship for a user. The invention also describes an interactive display system, and a method of performing a gaze-based interaction between a user and an interactive display system.

### BACKGROUND OF THE INVENTION

In recent years, developments have been made in the field of interactive shop window displays, which are capable of presenting product-related information using, for example, advanced projection techniques, in a more interesting manner to a potential customer looking at the display. The aim of such an interactive shop window is to present information about the product or products that specifically interest a potential customer. In this way, the customer might be more likely to enter the shop and purchase the item of interest. Also, presenting products and product-related information in this way contributes to a more interesting shopping experience. An advantage for the shop owner is that the display area is not limited to a number of physical items that must be replaced or arranged on a regular basis, but can display ‘virtual’ items using the projection and display technology now available. Such display systems are also becoming more interesting in exhibitions or museums, since more information can be presented than would be possible using printed labels or cards for each item in a display case.

Evidently, to present a user with meaningful information relating to items in a display such as a shop window or display case, it is necessary to first determine the direction in which he is looking, i.e. his gaze vector, in order to determine what he is actually looking at. Presenting the user with information that is of no interest to him would probably just be perceived as irritating. Obviously, one of the most accurate ways of determining the user gaze vector (in order to be able to deduce what the user is looking at) would be to track the motion of the user's eyes while tracking the motion of the user's head using a camera, and to apply advanced image analysis. The term ‘user gaze vector’ is used to refer to an approximation made by the system of the actual direction in which the user is looking. This vector can be determined relative to the user's head and to an established system reference point. Such systems are known from computer user interfaces in which the eye motion of a user seated in front of the computer is used to interact with an application. Eye-gaze tracking in such a controlled environment is relatively straightforward. For a ‘remote’ environment such as shop window or museum exhibit, however, in which a person could be standing anywhere in front of the display—in the middle, to one side, close by, or at a distance, eye-gaze tracking becomes more difficult to perform with accuracy. The term ‘remote’ is used to distinguish such applications from, for example, a personal computer based application where the user is seated close to the camera and the head is considered to be non-moving, i.e. the movements are so small as to be negligible. In “remote” gaze trackers, on the other hand, the head has much more freedom to move, since the user is also free to move. For this reason, the known systems monitor both head and eye movements and takes the superposition of the two vectors to determine the resulting gaze vector relative to an established system reference. At present, such systems are complex and expensive and are generally only applied in research labs.

In other attempts at addressing this problem, the movements of the head are used to deduce the direction in which the user is looking, referred to as remote head tracking. However, these systems are all based on the assumption that head pose or ‘user head heading’ is directly related to the user's eye gaze heading, i.e. it is assumed that the direction in which the head is facing coincides with the direction in which the user is looking. This is rarely the case, as will be explained below, and the disadvantage is that most users would need to exaggerate their head movement in order to successfully interact with the system. Just because a person is facing in a particular direction does not necessarily mean that he is also looking in that direction. It might well be that the person is indeed looking at a point some distance removed from the point at which his head is facing. For this reason, such systems work for some users and not for others. In an interactive shop-window application, if it is assumed that the head facing direction is the same as the eye-facing direction, the outcome may well be that, more often than not, the potential customer is presented with product-related information for products that do not interest him. Such unsatisfactory interaction might well lead to a rejection of this type of application.

Therefore, it is an object of the invention to provide an improvement over current methods and systems for remote determination of the direction in which a user is looking.

### SUMMARY OF THE INVENTION

The object of the invention is achieved by the method of determining a head-motion/gaze relationship for a user according to claim 1, a method of performing a gaze-based interaction according to claim 8, a system for determining a head-motion/gaze relationship according to claim 11, and an interactive display system according to claim 13.

The method of determining a head-motion/gaze relationship for a user according to the invention comprises the steps of allocating at least one first target and at least one second target in a display area. The user's gaze is attracted towards a first target and the user's head is observed to obtain a first head orientation measurement value. Subsequently, the user's gaze is attracted towards a second target and the user's head is observed to obtain a second head orientation measurement value. The head orientation measurement values are analysed to obtain a head-motion/gaze relationship for that user.

In the above method, according to the invention, the user's head orientation or ‘head pose’ can easily and inconspicuously be observed without any conscious participation by the user, i.e. the user's attention can be attracted to the targets in an unobtrusive way, so that it is not immediately obvious to the user that he is being involved in a calibration procedure. The user simply looks at items or objects that he would look at anyway. This obvious advantage of the method according to the invention means that the technical aspect of the calibration procedure remains hidden from the user, since a potential customer in front of a show window, or a visitor to a museum in front of an exhibit, can behave in an entirely natural manner.

It has been shown experimentally that there is a large variability between people in terms of their head movement propensity while looking at targets. In fact, the majority of people actually do not tend to align their head with their eye-gaze direction while looking at targets within a 50° frontal view. While some people show a tendency to move their heads more when changing their gaze direction, other people tend to move their heads only slightly. Also, experiments have shown that women, on average, tend to move their heads more than men. In the state of the art approaches described above, in which head headings are translated into gaze headings uniformly for all users, these differences are not taken into account, so that the majority of users would need to either exaggerate or attenuate their natural head movement in order to comply with the requirements of such systems, requiring conscious effort on their part. In fact, to effectively control such state of the art systems, a user would need to be trained first. In contrast, the method according to the invention offers a simple and elegant solution to the problem by offering a short unobtrusive calibration procedure, without necessarily requiring conscious participation on the part of a user, to determine the relationship between head-motion and gaze for that specific user. This can then be applied, as will be explained below, to determine the direction in which the user is looking, and therefore also the object at which he is looking, without the user having to move his head in a manner unnatural to him.

The method of performing a gaze-based interaction between a user and an interactive display system with a display area, according to the invention, comprises the steps of determining a head-motion/gaze relationship for the user using the method described in the preceding paragraphs. The method further comprises observing the user's head to obtain a head orientation measurement value, and the head-motion/gaze relationship is applied to the head orientation measurement value to estimate the gaze direction. The display area is subsequently controlled according to the estimated gaze direction.

The solution proposed by the independent claims is applicable for public displays offering head-gaze interaction, such as interactive shop windows, interactive exhibitions, museum interactive exhibits, etc.

An interactive display system according to the invention comprises a display area in which items are displayed or otherwise visually presented, an observation means, such as a camera arrangement, for observing a user's head to obtain a head orientation measurement value, and an analysis unit for analysing the head orientation measurement values of a user to determine a head-motion/gaze relationship for that user. The interactive display system further comprises a gaze direction estimation unit for applying the head-motion/gaze relationship to a head orientation measurement value of the user to estimate the user's gaze direction and a display area controller for controlling the display area on the basis of the estimated gaze direction.

After the head orientation measurement values, also called head pose vectors, have been obtained for the targets, these are analysed to determine the head-motion/gaze relationship that defines the translation between gaze shifts and head shifts for that user. The gaze direction estimation unit then applies this linear head-motion/gaze relationship to determine the gaze vector and thus to translate the detected head pose into the point of regard in the shop window, so that it can be determined at which object or item the user is looking. The system can then react appropriately, e.g. by presenting information about the object being looked at.

The system according to the invention allows for natural, untrained input essential for public interactive displays for which it is not desirable to have to train and/or inform users. Furthermore, even when a user is aware that the system is controllable by head movement, with the proposed solution he can deploy natural head movement as if he were naturally looking at items in the display area.

The dependent claims and the subsequent description disclose particularly advantageous embodiments and features of the invention.

Since it is desirable to control a display area according to the user in front of the display area, a calibration procedure using the method according to the invention should be initiated or triggered whenever a ‘new’ user appears to be interested in the display area. Generally, a person interested in an item in a display area such as a shop window will stop in front of the shop window and look inside. This would be a suitable opportunity to initiate a calibration. Therefore, an interactive display system according to the invention preferably comprises a detection means for detecting the presence of a user in front of the display area and generating a corresponding activation signal to initiate the calibration procedure. The detection means can be one or more pressure sensors or pressure tiles in the ground in front of the display area, any appropriate motion and/or presence sensor, or an infra-red or ultra-sound sensor. However, since the system according to the invention already comprises an observation means, typically one or more cameras, this could itself be used to detect the presence of a user in front of the display area, for example by applying image analysis to images obtained for the region in front of the display area where a user would be expected to stand. However, this approach might result in more energy consumption. Obviously, the type of detection means used will depend largely on the environment in which the display area is installed.

The positions of the first and second targets required by the calibration process are known to the system. For instance, the positions of the target items in the display area can be recorded in a configuration procedure, or whenever items are allocated to be targets (evidently, more than two targets can be used in the calibration process if desired or required, and any reference in the following to only a first and second target does not restrict the invention in any way to the use of only two targets). The position of the user relative to the target items can easily be determined, for example by means of a pressure sensor that supplies a signal when a person stands on it, or an infrared or ultrasound sensor placed in an appropriate location in front of the display area, or as indicated above, by applying image analysis to images obtained by the observation means. These ‘fixed’ points are used as reference points in the calibration procedure when determining the user's gaze vector. The head orientation or head pose measurement value is obtained using the observation means, also referred to as a head tracking device, which can comprise an arrangement of cameras, for example a number of moveable or static cameras mounted inside the display area to obtain an image or sequence of images, e.g. a ‘Smart Eye tracking device, and any suitable hardware and/or software modules required to perform image analysis

Knowing the positions of the first and second targets in three-dimensional space, and having a reliable estimate of the user's head pose relative to the target items, the head orientation measurement values can be analysed to determine the relationship between the head pose of the user and the direction in which he is looking. In the following, therefore, the term ‘head orientation measurement value’ may be understood to be any suitable value which can be used in obtaining an angular difference between head poses of the user for the first and second targets of a target pair.

In the experiments carried out, an essentially linear relationship was determined between the angular separation between targets looked at by the participants, and the observed amount of angular head motion made by a person when that person directed his gaze from one target to another. The remarkable discovery made in these experiments is that the amount of head motion that tends to be made by a person is characteristic of that person. In other words, the extent or proportion to which a person tends to move his head when directing his gaze from one object to the next remains essentially constant for that person, which is to be understood as follows, namely that one person might tend to move his head only slightly regardless of the distance between the objects, moving his eyes more, while another person might show considerably more head movement and less eye movement. This phenomenon was observed regardless of whether the items were close together or spaced further apart. This linear relationship R between gaze and angular head motion for a user can be expressed, for example, as:

R=Δ_{HM}/θ

where θ is the angular separation between the target items from the point of view of the user or person, and Δ_{HM} is the observed difference between the first and second head orientation measurement values. In a calibration process to determine the relationship for a user, the target items are preferably placed relatively far apart in order to obtain an accurate result.

The method according to the invention can use the obtained experimental results to estimate the gaze vector of the user. Particularly when the first and second targets can be widely spaced in the display area, one set of head orientation measurement values can suffice. However, the dimensions of some display areas may be restricted, and therefore too narrow to be able to place the first and second targets far enough apart. Furthermore, for users that hardly move their heads at all, a single target pair may not be sufficient to determine the head motion propensity with accuracy. Therefore, in a particularly preferred embodiment of the invention, at least two sets of targets are allocated in the display area, and head orientation measurements values are successively obtained for each set of targets. A set of targets can simply be a pair of targets, but evidently, a set is not limited to only two targets. For the sake of simplicity, however, the following explanation assumes that a target set simply comprises a pair of targets. In this alternative embodiment, a first set of two targets may be allocated to be as far apart as possible in the display area, and first and second head orientation measurement values obtained for these two targets. A second set of two targets can be allocated, separated by a smaller angular distance, and first and second head orientation measurement values can be obtained for these also. Using the additional information, the head motion propensity for the user can be estimated with more accuracy, so that his gaze can also be more accurately determined. Evidently, the sets of targets can overlap, i.e. one target pair might include a target that is also used in another target pair. This can be of advantage in a display area in which, for example, only a small number of items are arranged.

In this case, the linear relationship between gaze and angular head motion for a user can be expressed, for example, as

R₂₁=(Δ_{HM2}−Δ_{HM1})/(θ₂−θ₁)

Where θ₁ and θ₂ are the angular separations between the target items in the first and second sets of targets, respectively, again from the point of view of the user, and Δ_{HM1} and Δ_{HM2} are the observed angular head movements for the first and second sets of targets respectively. This can be better understood with the aid of FIG. 3a. For example, a first target pair may be separated by an angular distance of 25 degrees, and a second target pair might be separated by an angular distance of 15 degrees. The head orientation measurement values for a person, obtained using the method described above, can be used to determine a ‘line’ for that user, i.e. to determine the linear relationship between the head movements he makes and the direction in which he is looking when he does so.

The method of determining a head-motion/gaze relationship according to the invention can be applied in different ways. For example, the method can be applied to obtain head orientation measurements for a user, and, from these, the head-motion/gaze relationship for that user can be determined. Alternatively, the method can be applied to obtain head orientation measurements which are then compared to a collection of previously gathered data to estimate a head-motion/gaze relationship for that user. This second approach can be advantageous in applications where a quick result is desired, for instance in a retail environment. For example, a system for determining a head-motion/gaze relationship for a user, according to the invention, can avail of previously determined data similar to that shown in the graph of FIG. 3a. Measurements for a ‘new’ user can be made with two targets placed at a wide separation, say 30 degrees. The graph closest to the obtained head motion value, for instance, can then be assumed to describe the relationship between head-motion and gaze for that user.

In a later gaze-based interaction, the relationship determined using either of the techniques described can simply be applied to an observed head motion of the user, for example by ‘adjusting’ an observed angular head motion to deduce the region in the display area at which the user is likely to be looking. In this way, the particular head-motion tendencies of different people can easily be taken into consideration, and a more accurate gaze determination is possible, thus making the gaze interaction more interesting and acceptable to users.

When looking from one item to another in a display area, a user may move his head not only sideways, i.e. horizontally, but also up or down, i.e. vertically, in order to shift his gaze from one object to the next. Usually, products or items (that also act as targets items in the calibration process), are arranged in a two-dimensional plane in a shop window or display show-case, so that each item can be easily seen by a person looking in.

This is put to good use in a calibration process according to the invention, in which the user may be directed to look first at one item, then to look across to another item, and then up or down to yet another item. In this embodiment, the method according to the invention is applied to obtain a first head-motion/gaze relationship for a first direction or orientation, and subsequently the method is applied to obtain a second head-motion/gaze relationship for a second direction, where second direction is essentially orthogonal to the first direction. Usually, these orthogonal directions will be the horizontal and vertical directions in a plane parallel to the user, for example in a plane given by a shop window. Subsequently, the head orientation measurement values can be analysed to obtain a head-motion/gaze relationship for a horizontal direction, and optionally to obtain a head-motion/gaze relationship for a vertical direction. These can be combined to give an overall head-motion/gaze relationship with orthogonal horizontal and vertical factors, i.e. one factor relating the horizontal head motion to the horizontal component of the gaze heading, and another factor relating the vertical head motion to the vertical component of the gaze heading.

Evidently, the calibration can be carried out in a single step, i.e. directing the user to look at a first target, and then to direct his gaze diagonally up (or down) to the next target. In this preferred embodiment of the invention, the first and second head orientation measurement values each comprise at least horizontal and vertical vector components, and the first and second head orientation measurement values are analysed to obtain a head-motion/gaze relationship for a horizontal direction, and optionally to obtain a head-motion/gaze relationship for a vertical direction.

However, in the experiments carried out, it was observed that, for objects in a display area, people generally move their heads mostly sideways when directing their gaze from one object to another, so that the observed vertical head motion was considerably less than the observed horizontal head motion. On average, the vertical head motion was only about one third of the horizontal head motion. Therefore, particularly if the target items are arranged to lie essentially at the same level, i.e. on a horizontal plane such as a display shelf in a shop window, it can suffice to observe the horizontal head motion of a user. However, since items in a shop window or show case should not be limited to display on a single level, it may be desirable to apply a vertical factor to the observed head motions of the user in order to determine the point at which he is most likely looking at. Using the knowledge gained from the experiments described herein, a horizontal factor can be adjusted to obtain a vertical factor. Therefore, in a particularly preferred embodiment, the method of the invention is applied to obtain a first head-motion/gaze relationship for a first direction and a second head-motion/gaze relationship for a second direction, essentially orthogonal to the first direction, is derived from the first head-motion/gaze relationship. In a simple example, the head-motion/gaze relationship for the horizontal direction for a user can be simply divided by three to obtain a head-motion/gaze relationship for the vertical direction for that user.

In a preferred embodiment of the invention, the first target and the second target comprise distinct or separate items in the display area. In a shop window, for example, these objects can be products available in the shop. In an exhibit display case, the items can be exhibits for which descriptive information can be presented. Preferably, the first and second targets are the two most widely separated items in the display area. These target items can be defined in a system configuration procedure, and used in all subsequent user calibrations. For a user positioned centrally in front of the display area, this wide separation allows a more accurate calibration. However, a user can evidently position himself at any point in front of the display area, for example, to one side of the display area. Therefore, in a more flexible approach, the first and second targets can be allocated after the user has been detected, and according to the user's position in front of the display area. This ensures that, for a particular user, the target items can be comfortably looked at, and the angular separation of the target items is maximized from the point of view of the user, thus ensuring a more accurate head pose measurement.

A pertinent aspect of the invention is that the user is guided or encouraged to look at the target items so that the relationship between this user's head heading and gaze heading can be determined. Therefore, in a further preferred embodiment of the invention, a target in the display area is visually emphasised to attract the user's gaze towards that target. One way of emphasising a target item to attract the user's attention might be to have that item mounted on a turntable, which is then caused to rotate for an interval of time. In an alternative approach, visually emphasising an object or item can be done simply by highlighting that object while other objects are not highlighted. When using lighting to emphasise an object, the highlight effect could have a distinct colour, or could make use of conspicuous eye-catching effects such as a pulsating lighting effect, lighting being directed around the product, changing colours of light, etc. The aim of the visual emphasis is to intentionally encourage the user to look at the targets in turn. For a user interested in the contents of a display area, it can safely be assumed that the attention of the user will be drawn to the visually emphasised target. When one item of a number of items is visually emphasised, it is a natural reaction for the user to look at that emphasised item. The effectiveness can be increased if the visual emphasis occurs suddenly, i.e. with an abrupt onset. The user's head can be observed while the first and then the second target are emphasized, and the relationship between the monitored head movements and the assumed eye gaze direction can be determined using the known position of the user and the target items. The type of calibration described here is entirely passive or implicit, i.e. apart from the highlighting, the user is not given any indication that a particular procedure is being carried out.

The visual emphasis of the targets need not be limited to mere highlighting using spotlights or the like. With modern projection techniques, more interesting ways of drawing the user's attention to an item are given. Therefore, in a particularly preferred embodiment of the invention, a virtual cursor is projected in the display area to direct the user's gaze at a specific target. For example, an image of an arrow could be projected within the display area, dynamically guiding the user to look first at one target, and then at another target. The ‘cursor’ can also be an easily understandable symbol such as a pair of eyes that ‘look’ in the direction of the target item being highlighted, a finger that points in that direction, or a pair of footprints ‘walking’ in that direction. The virtual cursor can move across the display area towards the first target, which is then highlighted, so that the user's gaze can be assumed to rest on the first target. After a short interval, the virtual cursor can proceed to travel towards the second target, which is then also highlighted for a brief interval. This preferred embodiment allows an explicit calibration in which the user is aware that a procedure is being carried out in which he can participate. The advantage of this more entertaining approach is that it is more reliable in ensuring that the user actually looks at a target item, and that his focus of attention is not drawn to something else in the display area.

To keep the potential customer interested, the target items being visually emphasised can be described to the user. In a further preferred embodiment of the invention therefore, visually emphasising an item in the display area comprises visually presenting item-related information to the user. Again, this can be done using modern projection technology.

Therefore, in an interactive display system according to the invention, the display area preferably comprises a projection screen controlled according to an output of the detection module. The projection screen can be an electrophoretic display with different modes of transmission, for example ranging from opaque through semi-transparent to transparent. More preferably, the projection screen can comprise a low-cost passive matrix electrophoretic display. A user may either look through such a display at an object behind it when the display is in a transparent mode, read information that appears on the display for an object that is, at the same time, visible through the display in a semi-transparent mode, or see only images projected onto the display when the display is in an opaque mode.

Such a multiple-mode projection screen can be controlled as part of the calibration process, depending on the presence and actions of a user in front of the display area. For instance, in the case when no customers are detected in front of an interactive shop window, the shop window itself can be controlled, in a type of ‘stand-by mode’, to behave as a large projection screen used to display shop promotional content. Once a potential customer has been detected in front of the display area, as described above, the calibration procedure commences, and the screen displays a dynamic visual content close to the first target item in order to attract the shopper's attention to that item. The target could initially be invisible ‘behind’ the promotional content, and after a short interval, the screen close to that item becomes transparent or translucent, allowing the user to see the item. In this way, the target item is being visually emphasised. The system then can provide information about the first target item on the projection screen. Doing this will make the calibration more meaningful for the user, since he will not be looking at an item only for the sake of calibrating the system. After information relating to the first item has been displayed, the screen again becomes opaque in the region of the first target, behaving as a projection screen again in that area, and the procedure is repeated for the second target item. To guide the user to look at the second item, the system can also produce an arrow cursor moving in the direction of the second target. While the projection screen is being controlled to reveal the target items, the user's head motions are being monitored, and head pose measurement values are being measured. Once the calibration process is complete, and a head-pose/gaze direction relationship has been determined for that user, the screen can become entirely translucent, allowing the user to look at any item in the display area in order to be provided with content relating to each item that he chooses to look at. In a subsequent gaze-based interaction, the display area is controlled according to items looked at by user. For example, when the user looks at an item for a minimum predefined length of time, say 3 seconds, product-related information such as, for example price, available sizes, available colours, name of a designer etc., can be projected close to that item. When the user's gaze moves away from that object, the information can fade out after a suitable length of time, for example a predefined time interval.

Until interactive shop windows become commonplace, it may be preferable to provide users with a more explicit indication that a calibration procedure is taking place. Therefore, in a further preferred embodiment of the invention, a set of instructions is provided to the user to direct the user's gaze at a specific target. The instructions could be issued as a series of recorded messages output over a loudspeaker. However, in a noisy environment such as a shopping district or public area, this might be impracticable and unreliable. Therefore, the set of instructions should be preferably projected visually within the display area so that the user can easily ‘read’ the instructions. The set of instructions may comprise text to guide the user to look at the target items in sequence, e.g. the words “Look at the red bag on the left!”, followed by “And now please look at the brown shoes on the right!”. Again, projecting text in this way is made possible by the available projection system technology. Such a projector or projection module could be separate from the display area and positioned at any location within range of the display area. However, in a preferred embodiment of the invention, the interactive display system itself comprises a projection module for projecting a virtual cursor and/or a set of instructions or prompt in the display area.

In another embodiment, a large written instruction could be presented to the user, such that the width of the message comprises an approximately 30 degree visual angle. This message can be either statically defined on the shop window display or it could be dynamically generated dependent on the user's position so that it would be centred relative to the user. In this way, the instructions can be optimally positioned for good readability, regardless of where the user is standing relative to the display area. This is of particular advantage when considering that the visibility of a projected image can depend on the angle from which it is being seen.

The first and second targets need not necessarily be physical objects in the display area, but can be images projected at suitable points in the display area. For example, analogous to a window or menu item being opened on a computer desktop, the interactive display can cause a label to ‘pop up’ and attract the user's attention. The label might contain text, such as a message saying “Please look here” in a first target label and subsequently a message saying “And now look here” in a second target label. The user's head motions are observed to obtain head measurements or angular head transitions for these targets, and the calibration procedure continues as already described.

Following the calibration procedure, which may have been carried out with or without the user's knowledge, the display area can be controlled on the basis of the user's head pose. To this end, the method of gaze-based interaction comprises observing the user's head to obtain a head orientation measurement value and applying the head-motion/gaze relationship to the head orientation measurement value to estimate the gaze direction, and controlling the display area on the basis of the estimated gaze direction.

In a further development of the invention, the head-motion/gaze relationship for a user is stored in a memory and associated with that user. In this way, the relationship between head motion and gaze direction that characterizes a user can be applied in a particularly efficient manner, so that, once a user has been ‘calibrated’ using the technique described herein, the relationship describing the head motion propensity for this user can be stored and retrieved for use at a later point in time. This might be particularly advantageous when used in conjunction with, for example, a smart card incorporating an RFID (radio frequency identification) chip unique to a user. A customer with such a customer card might pause to look in a shop window associated with that customer card, for example a chain of stores that all offer that type of customer card. A calibration can be carried out the first time that user is ‘detected’, for example using an RFID reader close to the shop window. Information associating the user's RFID tag and his head-motion/gaze relationship can be stored in a central database. Thereafter, whenever that user approaches a shop window associated with that customer card, and the user's RFID tag is identified, that user's head-motion/gaze relationship is retrieved from the central database and applied to any subsequent head motions observed for that user. If an RFID-writer or similar device is used, the head-motion/gaze relationship may also be stored directly on the user's smart card and may be read from the card whenever it is used at another display area. Obviously, this application of the methods and systems according to the invention is not limited to retail environments, but might also be of interest in other exhibit-based environments such as museums or trade fairs, where smart cards can be distributed to visitors or customers, who might then approach any number of display areas or showcases in succession to look at their contents.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a schematic representation of a user in front of a display area;

FIG. 2a shows a schematic plan view of a display area and a first user;

FIG. 2b shows a schematic plan view of a display area and a second user;

FIG. 3a is a graph of horizontal head movement measurements for a number of participants;

FIG. 3b is a box plot of average horizontal head movements and vertical head movements for the participants of FIG. 3a;

FIG. 4a shows an interactive display system according to an embodiment of the invention;

FIG. 4b shows the interactive display system of FIG. 4a, in which a user is being guided to look at a first target item in a method according to the invention of determining a head-motion/gaze relationship;

FIG. 4c shows the interactive display system of FIG. 4b, in which the user is being guided to look at a second target item in a method according to the invention of determining a head-motion/gaze relationship;

FIG. 4d shows the interactive display system of FIGS. 4a-4c, in which the display area is controlled according to the user's gaze using a method of performing gaze-based interaction according to the invention.

FIG. 5 shows a cross section of a display area in an interactive display system with a projection screen according to another embodiment of the invention,

FIG. 6 shows an interactive display system according to a further embodiment of the invention.

In the drawings, like numbers refer to like objects throughout. Objects in the diagrams are not necessarily drawn to scale.

### DETAILED DESCRIPTION OF THE EMBODIMENTS

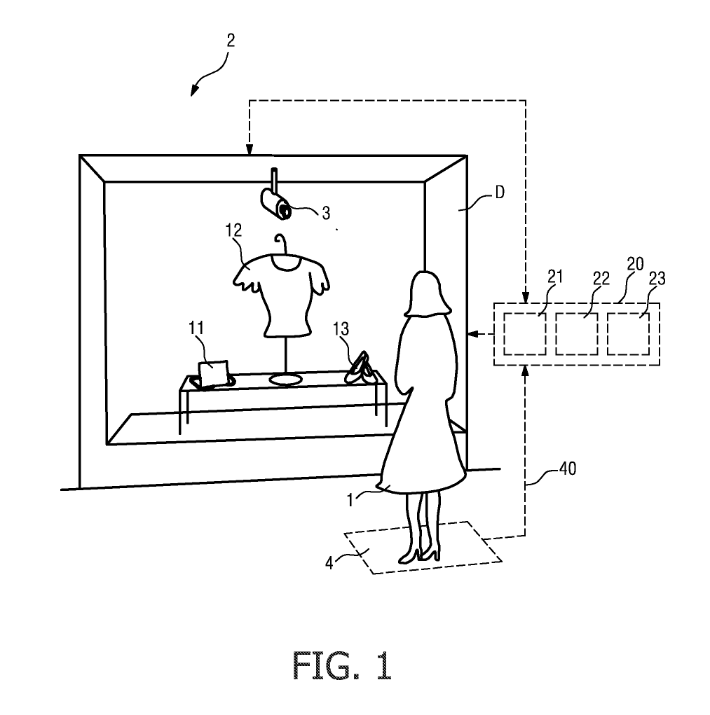

FIG. 1 shows a user 1 in front of a display area D, in this case a potential customer 1 in front of a shop window D. For the sake of clarity, this schematic representation has been kept very simple. In the shop window D, items 11, 12, 13 are arranged for display. A detection means 4, in this case a pressure mat 4, is located at a suitable position in front of the shop window D so that the presence of a potential customer 1 who pauses in front of the shop window D can be detected. An observation means 3, or head tracking means 3, with a camera arrangement is positioned in the display area D such that the head motion of the user 1 can be tracked as the user 1 looks at one or more of the items 11, 12, 13 in the display. The head tracking means 3 can be activated in response to a signal 40 from the detection means 4 delivered to a control unit 20. Evidently, the head tracking means 3 could, if appropriately realized, be used in lieu of the detection means 4 for detecting the presence of a user 1 in front of the display area D. In the diagram, only a single camera 3 is shown, but obviously any number of cameras could be implemented, and arranged unobtrusively in the display area D. The control unit 20 might comprise hardware and software modules, for example suitable algorithms running on a computer in an office or other room. In the diagram, a simplified representation of the control unit 20 is shown to comprise an analysis unit 21 to analyse the data supplied by the head tracker, and a gaze direction estimation unit 22 to determine a point being looked at by the user. A display area controller 23 is used to control elements of the display area, such as lighting effects and the presentation of product related information according to what the user is looking at. These modules 20, 21, 22, 23 will be explained later in more detail. Generally, the control unit 20 will be invisible to the user 1, and is therefore indicated by the dotted lines.

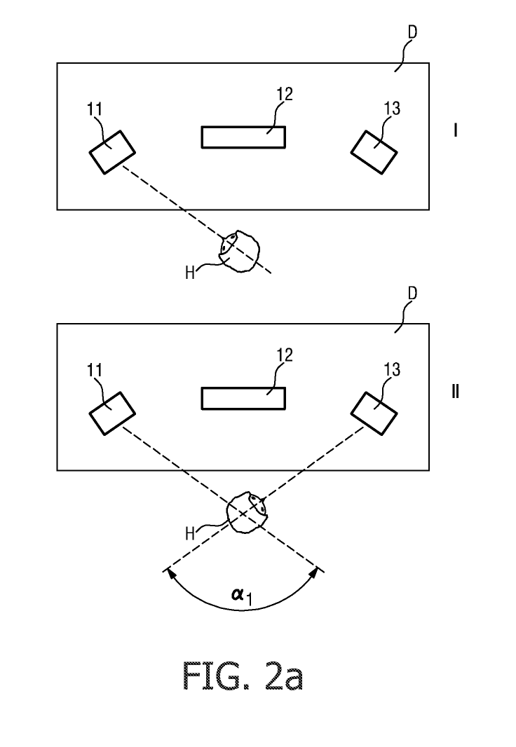

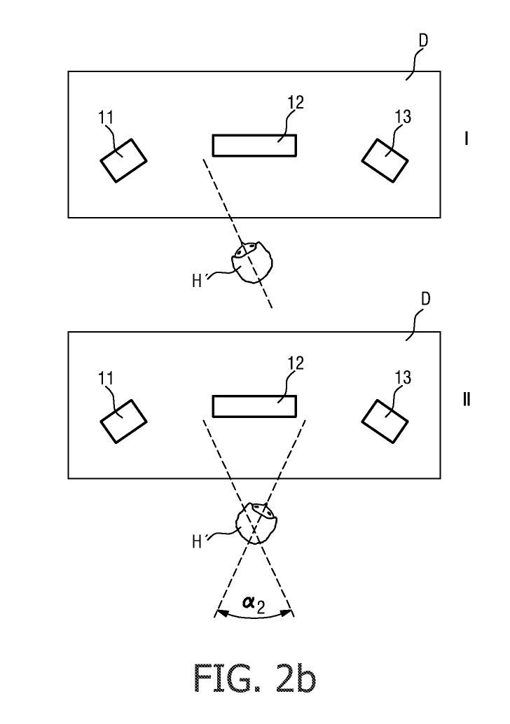

The degree by which a person tends to move his head when looking from one item to another has been observed to vary from person to person, as was explained above. FIGS. 2a and 2b graphically illustrate this observation, using as an example the display area D of FIG. 1 with items 11, 12, 13 represented by simple rectangular outlines. In FIG. 2a, a person looks at a first item 11 (I) and then at a second item 13 (II) in the display area D. This user moves his head by a relatively large amount, as indicated by the angle α₁, when changing his gaze from the first item 11 to the second item 13. In FIG. 2b, another person looks at the first and second items 11, 13 in turn. This person moves his head less, so that the degree α₂ of horizontal head motion for his head H′ is smaller than that of the first person. These diagrams illustrate the differences, in the amount of horizontal head motion, that can be observed between different people. Some will move their heads to a greater degree, while others might only move their heads slightly when looking from one item to another.

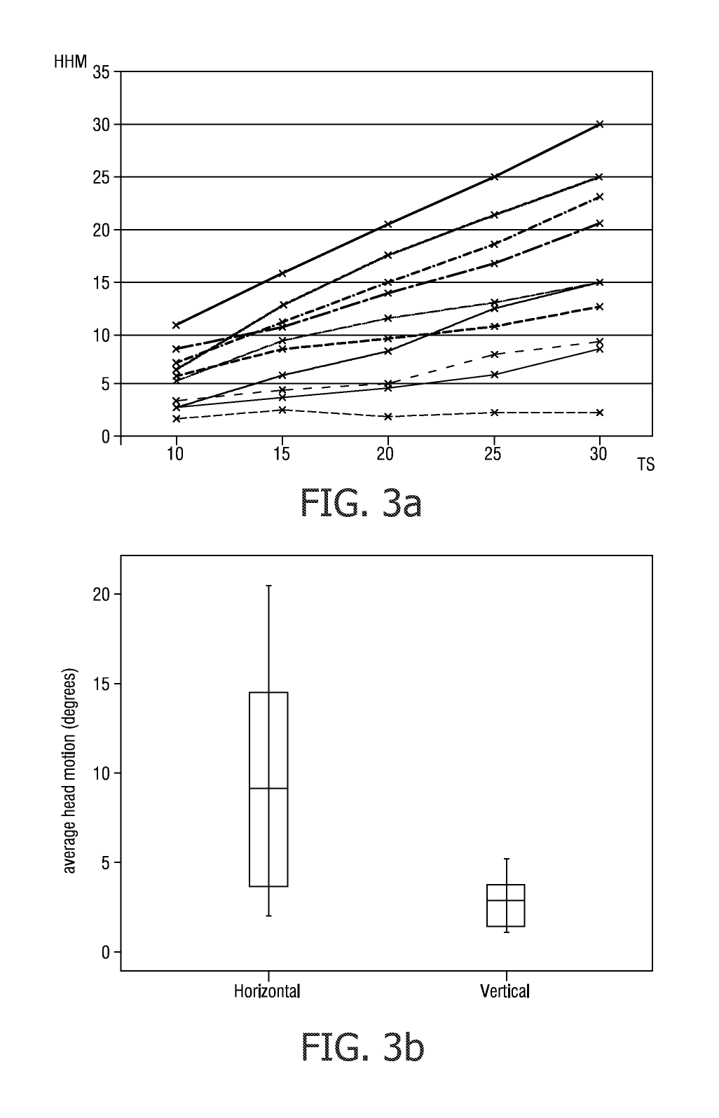

In FIG. 3a, results are shown of horizontal head movement in degrees (HHM) obtained for a number of participants, using target items arranged successively at different angular target separations in degrees (TS). In the experiments, the target items were arranged in a display area at predefined angular separations, i.e. at 10, 15, 20, 25 and 30 degrees, as indicated on the horizontal axis. Using a head tracking means such as Smart Eye, the degree of horizontal head movement was measured for each participant. Tests were carried out a number of times for each participant and angular separation, and the results were averaged. As can be seen clearly from the graph, the degree of horizontal head movement HHM (vertical axis) for each user shows a clear linear relationship to the degree of angular separation between the target items.

FIG. 3b shows a box-plot of the average horizontal and vertical head movements observed in the experiments. As can clearly be seen from the diagram, the average horizontal motion is considerably greater than the average vertical motion made by the participants. Instead of investing effort in measuring a vertical head-motion/gaze relationship for a user, this could be derived from the horizontal-motion/gaze relationship for that user. These observations are put to good use in the method according to the invention, as will be explained below.

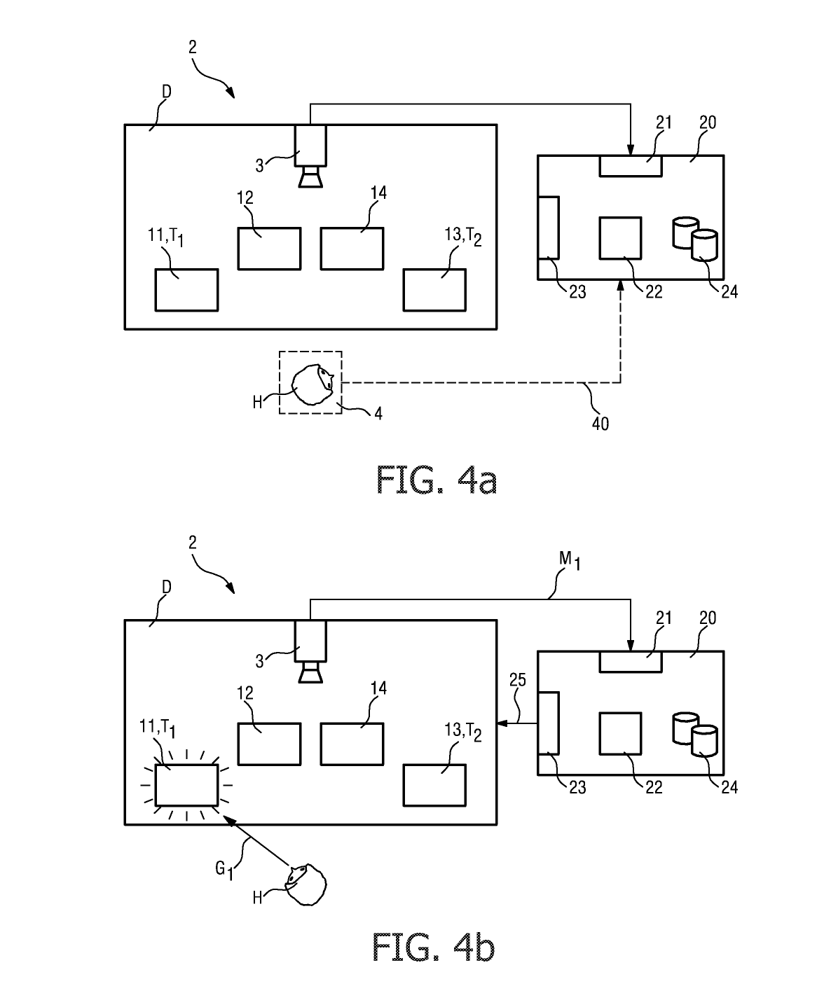

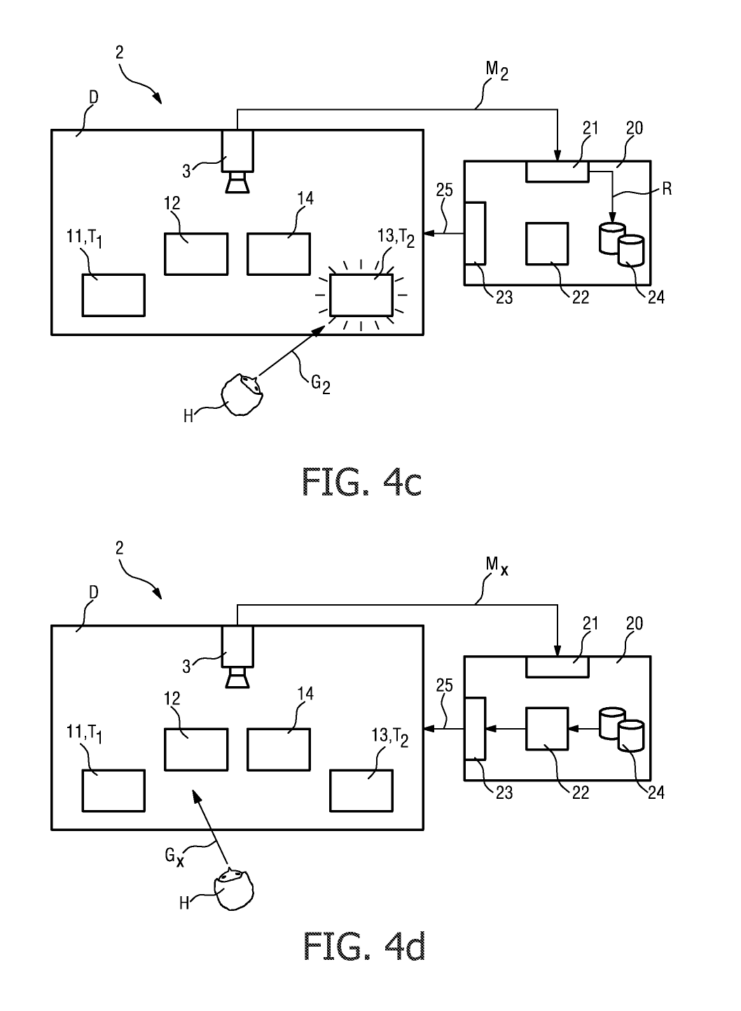

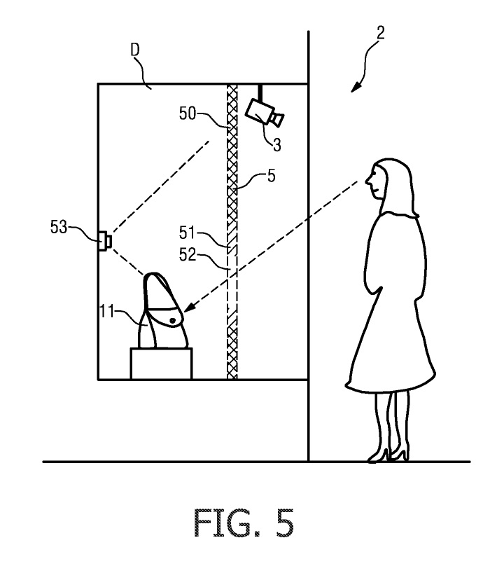

FIGS. 4a-4d show a plan view of a display area D, which can be a shop window D or any exhibit showcase D, to illustrate the steps in performing a gaze-based interaction according to the invention. Any number of items can be arranged in the display area D. For the sake of clarity, only a few items 11, 12, 13, 14 are shown, represented by simple rectangular outlines. A means of head tracking 3, such as a commercially available ‘Smart Eye®’ is shown to be arranged at a suitable position in the display area D to obtain digital images of a user. A customer is shown to be standing in front of the display area D. Only the head H of the customer (or user) is indicated. Using some suitable detecting means 4, such as a motion sensor, pressure sensor etc., the presence of the user is detected and a corresponding signal 40 is generated, initiating a calibration procedure to determine a head-motion/gaze relationship for the user in a method according to the invention. The user's position relative to the display area D can easily be determined using the detecting means 4 and/or the camera 3. Again, the head tracking means 3 itself could be used to detect a ‘new’ user in front of the display area D and to initiate the procedure to determine the head-motion/gaze-heading for that user.

In a first stage, shown in FIG. 4a, two items 11, 13 are assigned to be the first and second targets T₁, T₂ respectively. The choice of which items to use as targets is made based on the position of the user relative to the display area D, so that a large degree of angular separation can be achieved, giving more accurate results. For instance, if the user were to stand off to the left of the display area D, items 12 and 13 could be allocated as target items. The analysis unit 21, using image data from the camera 3, could therefore act as an allocation unit for deciding which items to use as target items.

Subsequently, in a next stage, shown in FIG. 4b, the user's attention is attracted to the first target T₁. This is achieved by a display area controller 23 which controls elements of the display area D to illuminate the first target T₁ so that it is highlighted. The user directs his gaze at the first target T₁, thereby moving his head H to a greater or lesser degree. The camera 3 observes the user's head H to obtain a first head orientation measurement value M₁. To hold the user's attention while the first head pose or head orientation measurement value M₁ is being obtained, product-related information about the first target item T₁ can be displayed, according to control signals issued by the display control unit 23.

In a next stage, shown in FIG. 4c, the second target T₂ is highlighted to attract the user's attention. The user's attention could also be drawn to the second target T₂ by having a virtual cursor appear to move across the display area D from the first target item T₂ towards the second target item T₂. Again, the user may move his head H to a greater or lesser degree to look at the second target T₂. The head tracker 3 is used to obtain a second head orientation measurement value M₂. Again, to hold the user's attention, product-related information about the second target item T₂ can be displayed while the second head orientation measurement value M₂ is being obtained. Knowing the user's position relative to the display area D, and knowing the angular separation between the target items T₁, T₂, a head-motion/gaze relationship R for the user can be determined using the first and second head orientation measurement values M₁, M₂.

This head-motion/gaze relationship R for this user can then be applied in a following gaze-based interaction as long as the user remains in front of the display area D, looking at other items 12, 14 in the display. Information relating to any item which he looks at can then be projected in some suitable manner in the display area D. This is shown in the fourth stage in FIG. 4d, in which the head tracking means 3 continues to monitor the user's head motion after the calibration procedure has completed. The head-motion/gaze relationship R is applied to any later head orientation measurement value Mₓ to estimate the user's gaze direction G. In the diagram, the estimated user's gaze Gₓ is shown to coincide with item 12, and a display area controller 23, having information about all the items 11, 12, 13, 14 in the display, can cause product-related information for this item 12 to be shown, for example by means of a holographic or electrophoretic screen.

FIG. 5 shows, in cross section, a variation on the display area D in an interactive display system, in which a customer is shown an image or images projected on a screen 5 instead of simply looking through the glass of the shop window or exhibit showcase. The screen 5 has different modes of operation, and can be opaque (showing an image), semi-transparent (allowing the user to partially see through) and completely transparent (so that the user can see an object 11 behind the screen 5). The different modes of the screen 5 are indicated by the different cross-hatchings in the diagram, so that an opaque region 50 of the screen is one upon which an image is being projected, a semi-opaque region 51 allows the user to partially see through, and a transparent region 52 allows the user to see right through. In this embodiment of the interactive display system, the camera or head tracker 3 is directed towards the front of the display area D to be able to follow the motion of the user's head.

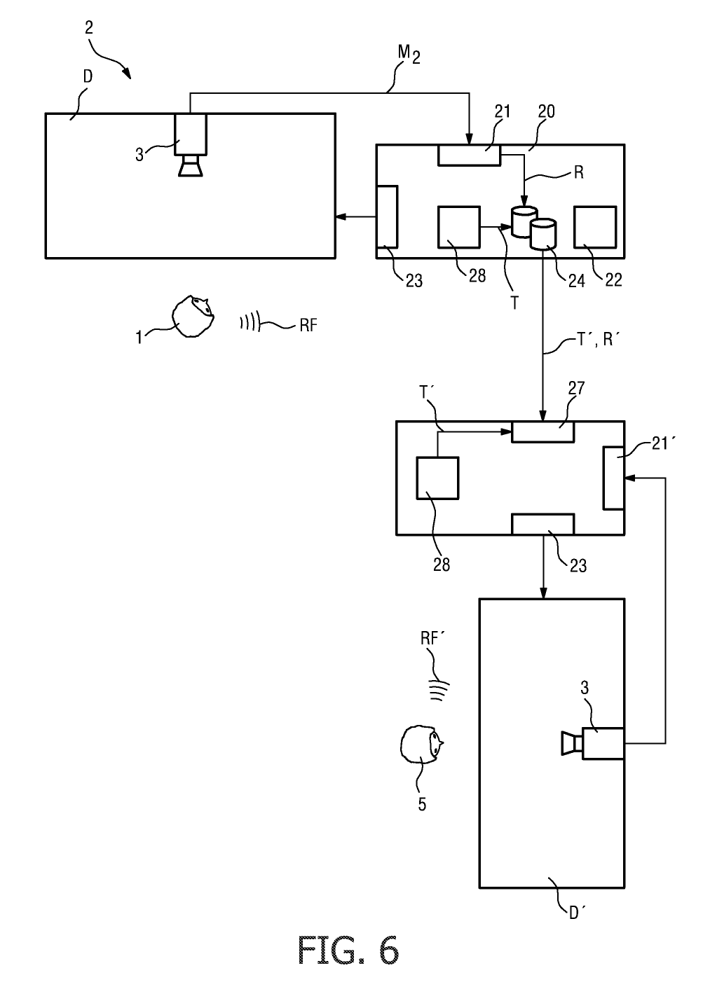

FIG. 6 shows a further realisation of an interactive display system according to the invention. Two display areas D, D′ are shown. A first user 1 is shown in front of a first display area D. A head-motion/gaze relationship R is determined for that user 1 as already described using FIGS. 4a-4d above. In this example, the control unit 20, in addition to the modules already described, also comprises an RFID reader 28. A signal RF emitted by an RFID tag (not shown) carried by that user 1 is detected by the reader 28, and used to generate a tag descriptor T for that user 1, which is then stored, in conjunction with the head-motion/gaze relationship R, in the memory 24 or central database 24.

Another user 5, for whom a head-motion/gaze relationship R′ has already been stored, as described in the previous step, is shown in front of a second display area D′. The control unit 20′ for this display area D′ also comprises an RFID reader 28. When a signal RF′ emitted by an RFID tag (not shown) carried by that user 5 is detected by the reader 28, which generates a tag descriptor T′ for that user 5 and causes an interface unit 27 to retrieve the head-motion/gaze relationship R′ for that tag descriptor T′ from the central database 24. This relationship R′ can then be applied to any head pose measurements made by a camera 3 during a subsequent gaze-based interaction between that user 5 and the display area D′. An analysis unit 21′ in the control unit 20′ can be a simplified version of the analysis unit 21 of the control unit 20, since this analysis unit 21′ does not necessarily have to perform calibration for a user.

When a user 1, 5 moves on and is no longer in the vicinity of a display area D, D′, this can be detected by the reader 28, and any gaze-based interaction that had taken place can be halted, for example by having a projection screen in the display area D, D′ return to a standby mode, should that be appropriate.

Evidently, the system shown can comprise any number of additional display areas, each with associated control units that can retrieve head-motion/gaze relationships from the central database 24 corresponding to detected RFID tags. Furthermore, each of the control units for the display areas might be capable of also performing calibration for a hitherto ‘uncalibrated’ user, but each can have the capability of inquiring in a central database 24 whether a tag descriptor is already stored in the central database 24, thus saving time and making the gaze-based interaction even more natural from the point of view of a user.

Although the present invention has been disclosed in the form of preferred embodiments and variations thereon, it will be understood that numerous additional modifications and variations could be made thereto without departing from the scope of the invention. For example, instead of physically arranging actual items in a display area, these could be virtually shown, for example projected on the display screen. With such an approach, the ‘contents’ of a display area can easily be changed at any time, for example using a computer user interface. The calibration procedure can be carried out in the same way, simply directing the user to look at a virtual item instead of a real one.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1. A method of determining a head-motion/gaze relationship for a user (1), which method comprises the steps of
allocating at least one first target (T1) and at least one second target (T2) in a display area (D) of a remote environment;
attracting the user's gaze towards the first target (T1) and observing the user's head (H) to obtain a first head orientation measurement value (M1);
subsequently attracting the user's gaze towards the second target (T2) and observing the user's head (H) to obtain a second head orientation measurement value (M2);
analysing the head orientation measurement values (M1, M2) to determine a head-motion/gaze relationship (R) for that user (1).

2. A method according to claim 1, wherein the first and second head orientation measurement values (M1, M2) each comprise at least horizontal and vertical vector components, and the first and second head orientation measurement values (M1, M2) are analysed to obtain a head-motion/gaze relationship for a horizontal direction, and optionally to obtain a head-motion/gaze relationship for a vertical direction.

3. A method according to claim 1 wherein the method is applied to obtain a first head-motion/gaze relationship for a first direction and subsequently the method is applied to obtain a second head-motion/gaze relationship for a second direction, which second direction is essentially orthogonal to the first direction.

4. A method according to claim 1, wherein the method is applied to obtain a first head-motion/gaze relationship for a first direction, and a second head-motion/gaze relationship for a second direction, essentially orthogonal to the first direction, is derived from the first head-motion/gaze relationship.

5. A method according to claim 1 wherein a target (T1, T2) in the display area (D) is visually emphasised to attract the user's gaze towards that target (T1, T2).

6. A method according to claim 1, wherein at least two sets of targets (T1, T2) are allocated in the display area (D), and head orientation measurements values are successively obtained for the targets of each set of targets (T1, T2).

7. A method according to claim 1, wherein the head-motion/gaze relationship (R) for a user (1) is stored in a memory and associated with that user (1).

8. A method of performing a gaze-based interaction between a user (1) and an interactive display system (2) comprising a display area (D) of a remote, which method comprises the steps of
determining a head-motion/gaze relationship (R) for the user (1) using a method according to claim 1
observing the user's head (H) to obtain a head orientation measurement value (Mx);
applying the head-motion/gaze relationship (R) to the head orientation measurement value (Mx) to estimate the gaze direction (Gx); and
controlling the display area (D) on the basis of the estimated gaze direction (Gx).

9. A method according to claim 8, wherein an item in the display area (D) is identified on the basis of the estimated gaze direction (Gx) of the user (1), and the display area (D) is controlled to visually emphasise that item.

10. A method according to claim 9, wherein visually emphasising an item in the display area (D) comprises visually presenting item-related information to the user (1).

11. A system (4) for determining a head-motion/gaze relationship for a user (1), which system comprises
an allocation unit for allocating at least one first'target (T1) and at least one second target (T2) in a display area (D) of a remote environment;
a control unit for controlling the display area (D) to attract the user's gaze towards the first target (T1) and to subsequently attract the user's gaze towards the second target (T2);
an observation means (3) for observing the user's head (H) to obtain a first head orientation measurement value (M1) related to the first target (T1) and a second head orientation measurement value (M2) related to the second target (T2); and
an analysis unit for analysing the head orientation measurement values (M1, M2) to determine a head-motion/gaze relationship (R) for that user (1).

12. A system (4) according to claim 11, comprising a storage means for storing a head-motion/gaze relationship (R, R′) for a user (1), and an association means for associating a user (1) with a stored head-motion/gaze relationship (R′).

13. An interactive display system (2) comprising
a display area (D) of a remote environment, in which items are displayed;
a means for obtaining a head-motion/gaze relationship (R) for a user (1);
an observation means (3) for observing a user's head (H) to obtain a head orientation measurement value (Mx);
a gaze direction estimation unit for applying the head-motion/gaze relationship (R) to the head orientation measurement value (Mx) of the user (1) to estimate the user's gaze direction (Gx); and
a display area controller for controlling the display area (D) on the basis of the estimated gaze direction (Gx).

14. An interactive display system (2) according to claim 13 comprising a system (4) for determining a head-motion/gaze relationship (R) for a user.

15. An interactive display system (2) according to claim 13 wherein the display area (D) comprises a projection screen (5), which projection screen (5) is controlled according to an output of the display area controller.
